(19) United States
(12) Patent Application Publication
(10) Pub. No.: US 2010/0148407 A1
(43) Pub. Date: Jun. 17, 2010

(54) Imprint Mold, Imprint Apparatus and Method of Forming Pattern

(76) Inventors: Dae-Jin PARK, Yeonsu-gu (KR); Kyu-Young KIM, Suwon-si (KR); Hyung-Il JEON, Nam-gu (KR)

Correspondence Address: F. CHAU & ASSOCIATES, LLC, 130 WOODBURY ROAD, WOODBURY, NY, 11797, US

(21) Appl. No.: 12/569,247

(22) Filed: Sep. 29, 2009

(30) Foreign Application Priority Data
Dec. 15, 2008 (KR) 10-2008-0127321

(51) Int. Cl. B29C 35/08; B28B 21/42; B29C 55/00

(52) U.S. Cl. 264/496; 425/470; 264/291

(57) ABSTRACT

An imprint apparatus includes an imprint mold including a flexible base plate with a coefficient of thermal expansion (CTE) of about 17 ppm/° C. or less, and a mold pattern formed on the base pattern.

This application claims priority to Korean Patent Application No. 10-2008-0127321 filed on Dec. 15, 2008 in the Korean Intellectual Property Office, the contents of which are herein incorporated by reference in their entirety.

### BACKGROUND OF THE INVENTION

1. Field of the Invention

The present disclosure is directed to an imprint mold, an imprint apparatus and a method of forming a pattern, and more particularly, to an imprint mold which cannot be substantially deformed by heat, can achieve high precision, and can be transformed into various shapes, an imprint apparatus including the imprint mold and a method of forming a pattern using the imprint mold.

2. Description of the Related Art

In recent years, the demand for flat panel displays such as a plasma display panel (PDP), a plasma-addressed liquid crystal (PALC) display, a liquid crystal display (LCD) and an organic light-emitting diode (OLED) has significantly increased because conventional cathode ray tube (CRT) devices cannot meet the demand for thin, large-scale display devices.

As the size of display devices increase, the size of the glass substrates for forming a display device has gradually increased. Display devices are generally manufactured by patterning various devices on a glass substrate using a photolithography method. However, due to increases in the size of the glass substrates for forming a display device, challenges have arisen, such as increases in the costs of fabricating large-scale masks and investing in manufacturing equipment, and challenges in forming minute patterns due to wavelength limitations of the light used for exposure.

Typical imprint molds use glass substrates to minimize thermal deformation. However, imprint molds using glass substrates are likely to break if deformed into other shapes. Thus, there are restrictions on handling imprint molds using glass substrates.

Therefore, it is desirable to develop imprint molds that can be formed of a flexible material, can be transformed into various shapes, are substantially undeformable by heat and can be used to form minute patterns.

### SUMMARY OF THE INVENTION

Aspects of the present invention provide an imprint mold which is substantially undeformable by heat, can achieve high precision, and can be transformed into various shapes, and an imprint apparatus including the imprint mold.

Aspects of the present invention also provide a method of forming a pattern using an imprint mold which is substantially undeformable by heat, can achieve high precision and can be transformed into various shapes.

According to an aspect of the present invention, there is provided an imprint mold comprising: a flexible base plate with a coefficient of thermal expansion (CTE) of about 17 ppm/° C. or less; and a mold pattern formed on the base pattern.

According to an aspect of the present invention, there is provided an imprint apparatus comprising: an imprint mold including a flexible base plate with a coefficient of thermal expansion (CTE) of about 17 ppm/° C. or less, and a mold pattern formed on the base pattern.

According to another aspect of the present invention, there is provided a method of foaming a pattern, the method comprising: forming an imprint mold including a flexible base plate with a coefficient of thermal expansion (CTE) of about 17 ppm/° C. or less, and a mold pattern formed on the base pattern; applying a curable material on a substrate; and pressing the imprint mold on the curable material.

According to another aspect of the present invention, there is provided a method of manufacturing a thin-film transistor (TFT) pattern, the method comprising: forming an imprint mold including a flexible base plate with a coefficient of thermal expansion (CTE) of about 17 ppm/° C. or less, and a mold pattern formed on the base pattern; applying a curable material on a substrate; pressing the imprint mold on the curable material; and curing the curable material.

### BRIEF DESCRIPTION OF THE DRAWINGS

FIGS. 1 through 3 are cross-sectional views for illustrating a method of manufacturing an imprint mold according to an exemplary embodiment of the present invention.

FIGS. 4 through 9 are diagrams for illustrating a method of forming a pattern using an imprint apparatus according to an exemplary embodiment of the present invention.

FIGS. 10 through 12 are diagrams for illustrating a method of forming a pattern using an imprint apparatus according to another exemplary embodiment of the present invention.

FIGS. 13 through 27 are cross-sectional views for illustrating the manufacture of a thin-film transistor (TFT) substrate using a method of forming patterns according to an exemplary embodiment of the present invention.

### DETAILED DESCRIPTION OF EXEMPLARY EMBODIMENTS

Features of embodiments of the present invention and methods of accomplishing the same may be understood more readily by reference to the following detailed description of exemplary embodiments and the accompanying drawings. Embodiments of the present invention may, however, be embodied in many different forms and should not be construed as being limited to the embodiments set forth herein. Like reference numerals refer to like elements throughout the specification.

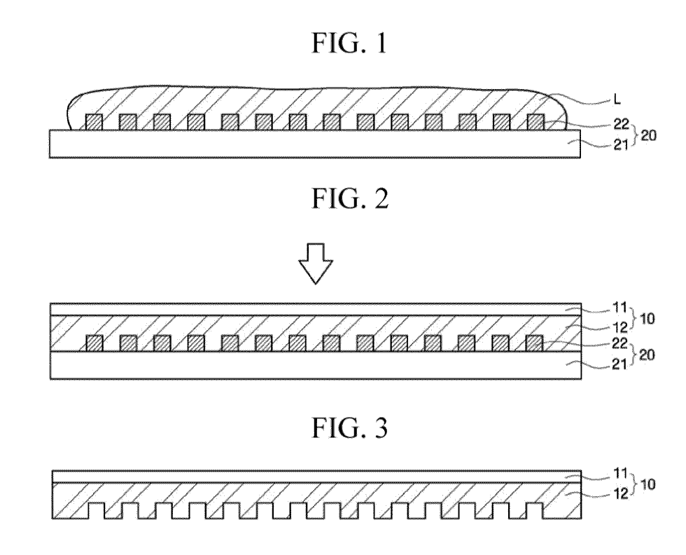

A method of manufacturing an imprint mold according to an exemplary embodiment of the present invention will hereinafter be described in detail with reference to FIGS. 1 through 3. FIGS. 1 through 3 are cross-sectional views for illustrating a method of manufacturing an imprint mold according to an exemplary embodiment of the present invention.

Referring to FIG. 1, a material L for forming a mold may be applied onto a master mold 20. The master mold 20 is a mold for forming an imprint mold 10 of FIG. 3. By using the master mold 20, a plurality of mold patterns 12 of FIG. 3 may be formed on one surface of the imprint mold 10.

The master mold 20 may include a master plate 21 and a master pattern 22. To manufacture a plurality of imprint molds 10, the master mold 20 may be formed of a material that can minimize the deformation of the master mold 20 even after several processes. For example, the master plate 21 may be formed of a material such as glass that is substantially undeformable even by a high-temperature process. The master pattern 22 having a desired shape may be foamed on the master plate 21. The master pattern 22 may be formed on the master plate 21 using photolithography. The master pattern 22 may be formed in one body with the master plate 21.

The material L may be applied onto the master pattern 22 of the master mold 20. The material L may be a transparent resin such as a thermosetting resin or a photo-curable resin. A photoactive compound may be added to the transparent resin as an additive. More specifically, a photo-curable resin such as 1,6-hexanediol-diacrylate (HDDA), a novolak resin and bis(hydroxyethyl)bisphenol-A dimethacrylate (HEBDM) or a thermosetting resin such as a phenol resin, an epoxy resin, a silicon resin, acetate or polyimide may be used as the material L.

Thereafter, referring to FIG. 2, a base plate 11 may be laid over the material L, and the material L may be cured, thereby forming a mold pattern 12.

The base plate 11 may be formed of a flexible soft film, which is a plate that can be somewhat deformed by the application of an external force. Thus, the base plate 11 may be rolled or folded so that the size of the base plate 11 can be reduced.

The base plate 11 may be formed of a transparent material that can transmit light therethrough. More specifically, the base plate 11 may be formed of a transparent plastic-type resin. The thickness of the base plate 11 may be appropriately adjusted according to a required rigidity for forming the imprint mold 10. The base plate 11 may be formed as a thin film and may include transparent fibers. Transparent fibers may be fiberglass. More specifically, the base plate 11 may be formed as a transparent fabric by weaving transparent fibers. For example, the base plate 11 may be formed by twisting glass filaments into yarn and weaving the yarn into fiberglass fabric. The base plate 11 may be formed using various weaving methods such as plain weaving, twill weaving, satin weaving, lene plain weaving and mock Leno weaving. Therefore, the base plate 11 may be formed by impregnating fiberglass or fiberglass yarn or fabric with an organic resin such as an epoxy resin, by forming a thin fiber film or fiber fabric or by depositing fibers or thin fiber films.

A thermosetting resin such as an epoxy-based resin, a phenol resin, a phenol-epoxy resin blend or a bis male imide-triazin resin blend or a thermoplastic resin such as polycarbonate, polyethersulfone or polyetherimide may be used to form the base plate 11.

The base plate 11 may be somewhat deformed by application of an external force. In addition, the base plate 11 may support the imprint mold 10 against an external force.

For the imprint mold 10 to have not only optical properties but also mechanical properties, such as thermal dimension stability, the base plate 11 may contain transparent fibers. If the base plate 11 is formed of a material having a high coefficient of thermal expansion (CTE) such as plastic, the precision of the imprint mold 10 may decrease. On the other hand, if the base plate 11 is formed of transparent fibers such as fiberglass, the CTE of the base plate 11 may decrease, and thus, the stability of the imprint mold 10 may increase. The base plate 11 may be formed of fiberglass fabric so that the CTE of the base plate 11 can be uniform throughout all four directions of the base plate 11. A base plate 11 formed of fiberglass fabric is referred to as fiber-reinforced plastic.

The base plate 11 may have flexibility, and may have a CTE of about 17 ppm/° C. or less. If the base plate 11 is formed by impregnating fiberglass having a CTE of about 5.5 ppm/° C. with resin, the CTE of the base plate 11 may increase. In this case, the base plate 11 may be formed to have a CTE of about 7.2-7.3 ppm/° C. or less. If the mold pattern 12 is formed on the base plate 11, the CTE of the base plate 11 may vary.

The amount by which the imprint mold 10 is deformed by heat may need to be controlled to fall within the error range of an alignment key, i.e., the range of about −2.5 μm to about +2.5 μm. This will hereinafter be described in further detail, taking a panel having a size of about 370 mm by about 470 mm as an example.

Since polycarbonate has a CTE of about 70 ppm/° C., a polycarbonate panel having a size of about 370 mm by about 470 mm may in theory be deformed diagonally by about 40 μm by a temperature variation of about 1° C. However, in reality, a polycarbonate panel is deformed diagonally only by about 30 μm. Given this, the mold pattern 12 on the base plate 11 may reduce the deformation of a substrate. In consideration that there exists a force that can compensate for the deformation of the base plate 11 by about 10 μm, it is possible to form an imprint mold 10 whose deformation is within the error range of an alignment key by controlling the deformation amount of the base plate 11 subject to heat to be less than or equal to about 10 μm.

In this manner, the permissible CTE of the base plate 11 may be determined to be about 17 ppm/° C.

The base plate 11 may be laid over the material L, and pressure may be applied to the base plate 11, thereby molding the material L. Thereafter, the molded material may be cured using either thermal setting or photo-curing, thereby forming the mold pattern 12.

Thereafter, referring to FIG. 3, the master mold 20 may be removed from the mold pattern 12, thereby completing the formation of the imprint mold 10.

The mold pattern 12 may be attached to one surface of the base plate 11. The mold pattern 12 and the base plate 11 may form a flexible imprint mold 10 by being coupled to one another. The imprint mold 10 may be formed of a transparent material and may thus be able to transmit light therethrough. The imprint mold 10 may maintain its shape as a plate or may be rolled.

The imprint mold 10 may be used to form a pattern. More specifically, it is possible to form a pattern by pressing a fluid material onto the mold pattern 12 of the imprint mold 10.

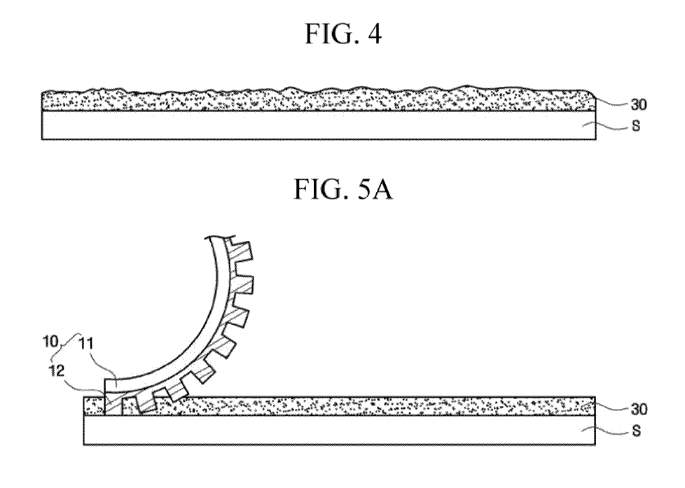

A method of forming a pattern using an imprint apparatus according to an exemplary embodiment of the present invention, will hereinafter be described in detail with reference to FIGS. 4 through 9. FIGS. 4 through 9 are diagrams for illustrating a method of forming a pattern using an imprint apparatus according to an exemplary embodiment of the present invention.

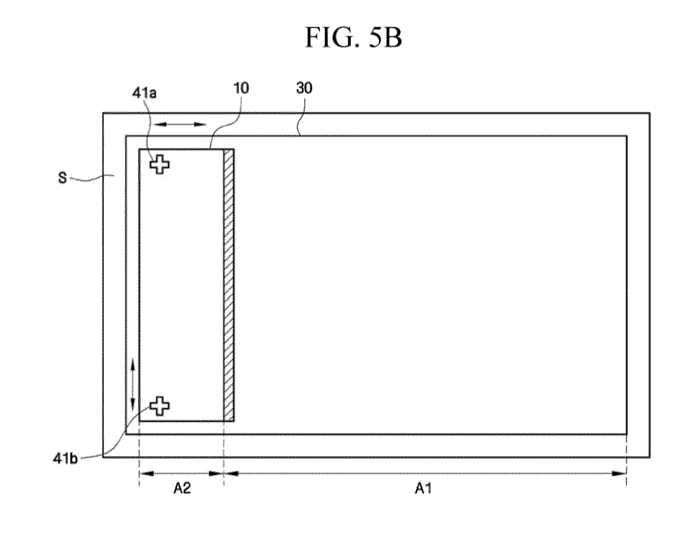

Referring to FIG. 4, photoresist 30, which is a photo-curable organic material, may be applied onto a substrate S in consideration of the thickness of a desired mold pattern (i.e., a mold pattern 12 of FIG. 5A). However, the material to be molded by the mold pattern 12 is not restricted to a photo-curable organic material, i.e., the photoresist 30. That is, the mold pattern 12 may be used to form materials other than a photo-curable organic material, such as a thermosetting resin or a photo-curable resin.

Thereafter, referring to FIGS. 5A and 5B, a first end of the imprint mold 10 may be placed in contact with photoresist 30. More specifically, the imprint mold 10 is formed of a flexible material. A first end of the imprint mold 10 may be placed in contact with the photoresist 30 first, and then, the rest of the imprint mold 10 may be gradually attached onto the photoresist 30 while gradually increasing the contact area of the imprint mold 10 and the photoresist 30. As a result, a pattern may be formed on the photoresist 30.

More specifically, the imprint mold 10 may be aligned with the substrate S using align masks 41a and 41b when only the first end of the imprint mold 10 is placed in contact with the photoresist 30.

Since the adhesive force between the photoresist 30 and the mold pattern 12 is very strong, it is almost impossible to properly align the imprint mold 10 with the substrate S once the imprint mold 10 is completely attached onto the photoresist 30. In addition, the imprint mold 10 may be damaged during the alignment of the imprint mold 10 with the substrate S.

Therefore, only the first end of the imprint mold 10, which is formed of a flexible material, may be placed in contact with the photoresist 30, and then, the imprint mold 10 may be aligned with the substrate S. Thereafter, the rest of the imprint mold 10 may be attached onto the photoresist 30.

In this manner, it is possible to quickly align the imprint mold 10 with the substrate S by application of a weak force.

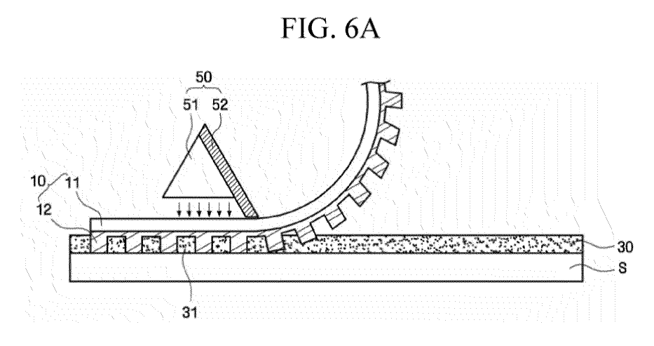

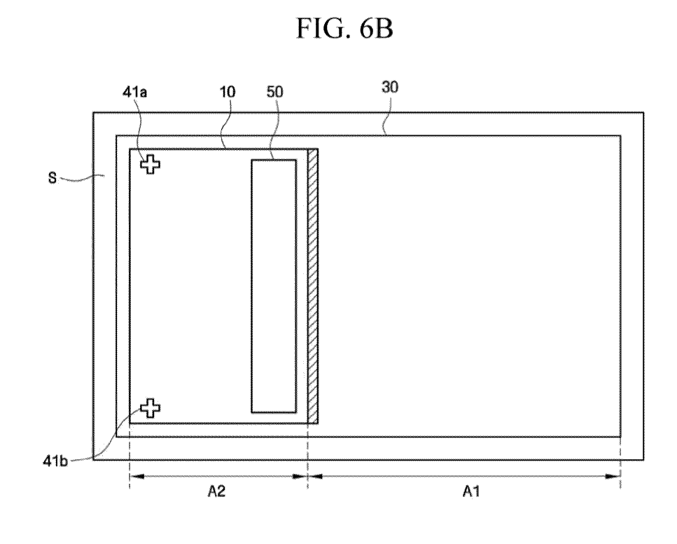

Thereafter, referring to FIGS. 6A and 6B, the photoresist 30 may be cured while placing the imprint mold 10 in contact with the photoresist 30.

The first end of the imprint mold 10 may be placed in contact with the photoresist 30 first, and then, the rest of the imprint mold 10 may be gradually attached onto the photoresist 30 while gradually increasing the contact area of the imprint mold 10 and the photoresist 30. More specifically, the imprint mold 10 may be initially wound into a roll. In this case, the imprint mold 10 may be gradually attached onto the photoresist 30 by being gradually unrolled.

A curing unit 50 may photo-cure the photoresist 30 on which the imprint mold 10 is attached, while pressing the imprint mold 10. The curing unit 50 may include a press element 52 pressing the imprint mold 10 and a lamp 51 disposed near the press element 52.

The curing unit 50 may press the imprint mold 10 on the substrate S while slowly moving from the first end to a second end of the imprint mold 10. The direction in which the curing unit 50 moves may be the same as the direction in which the imprint mold 10 is being gradually attached onto the photoresist 30. The curing unit 50 may move at the same speed as the speed at which the imprint mold 10 is being gradually attached onto the photoresist 30.

The press element 52 may be formed at the front of the curing unit 50, and the lamp 51 may be disposed at the rear of the press element 52. That is, the shape of the mold pattern 12 may be transferred onto the photoresist 30 by the press element 52, and the photoresist 30 may be photo-cured by light emitted from the lamp 51.

The press element 52 may press the imprint mold 10 while sliding along the surface of the imprint mold 10. The press element 52 may be disposed in contact with the surface of the imprint mold 10. The lamp 51 may be disposed near the press element 52, and may form a pattern 31 by curing the photoresist 30.

The photoresist 30 may be divided into an uncured area A1 yet to be in contact with the imprint mold 10 and a cured area A2 already in contact with the imprint mold 10 and already processed by the curing unit 50. The uncured area A1 may be transformed into a cured area A2 by being processed by the curing unit 50.

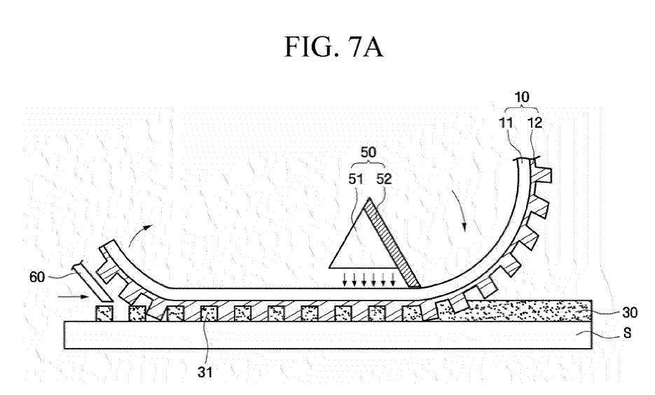

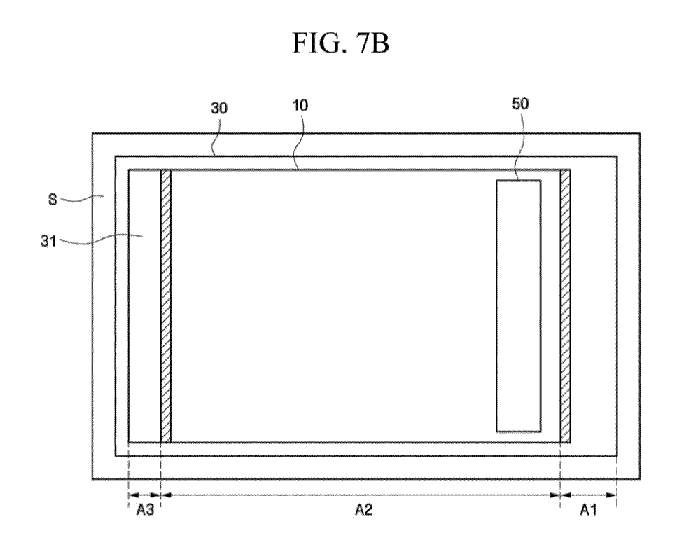

Thereafter, referring to FIGS. 7A and 7B, the pattern 31 may be formed by gradually detaching the imprint mold 10 from the photoresist 30 while gradually attaching the imprint mold 10 onto the photoresist 30.

As described above, the imprint mold 10 may be gradually attached onto the photoresist 30, and the curing unit 50 may move over the imprint mold 10. Part of the imprint mold 10 corresponding to part of the photoresist 30 already cured may be detached from the substrate S. More specifically, the imprint mold 10 may be detached from the substrate S in such a manner that part of the imprint mold 10 placed in contact with the photoresist 30 first can be detached first from the substrate S.

The imprint mold 10 may be detached from the substrate S by a separating element 60. The separating element 60 may be inserted between the substrate S and the imprint mold 10 and may thus detach the imprint mold 10 from the substrate S by pushing up the imprint mold 10.

Referring to FIG. 7B, during the detachment of the imprint mold 10 from the substrate S, the photoresist 30 may be divided into an uncured area A1, a cured area A2 and a pattern area A3.

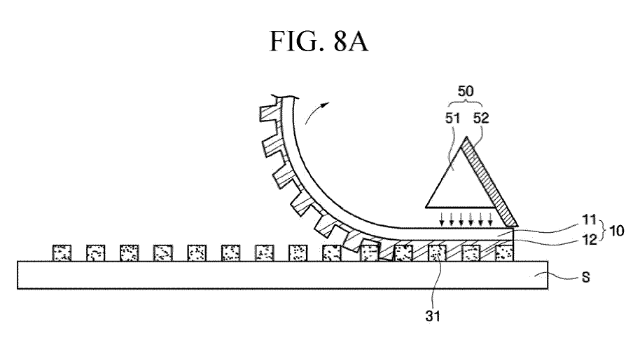

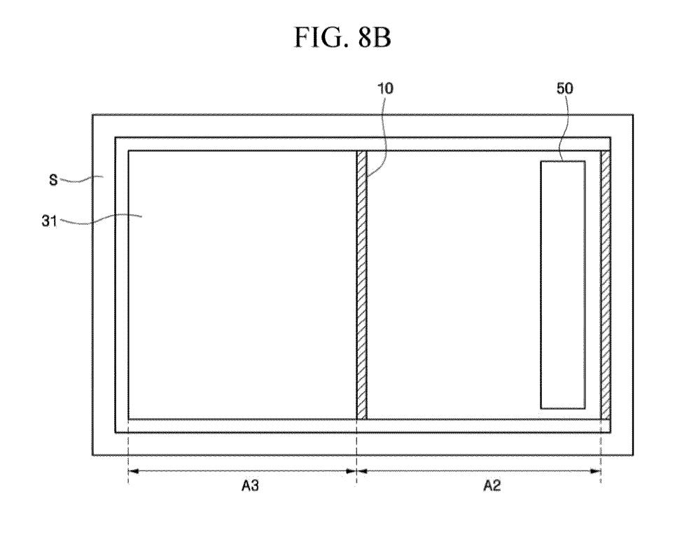

Thereafter, referring to FIG. 8A, when the curing unit 50 arrives at the second end of the imprint mold 10, the whole photoresist 30 may be cured. The detachment of the imprint mold 10 from the substrate S may still continue along the same direction as the moving direction of the curing unit 50. In this case, referring to FIG. 8B, the photoresist 30 may be divided into a cured area A2 and a pattern area A3. As the detachment of the imprint mold 10 from the substrate S progresses, the pattern area A3 may gradually widen.

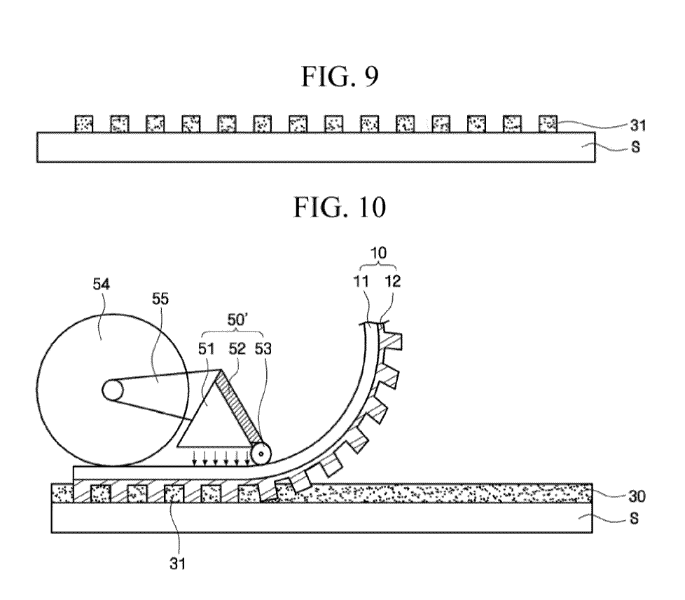

Thereafter, referring to FIG. 9, once the imprint mold 10 is completely detached from the substrate S, the formation of the pattern 31 may be complete.

A method of forming a pattern using an imprint apparatus according to another exemplary embodiment of the present invention will hereinafter be described in detail with reference to FIGS. 10 through 12. FIGS. 10 through 12 are diagrams for illustrating a method of forming a pattern using an imprint apparatus according to another exemplary embodiment of the present invention. The exemplary embodiment of FIGS. 10 through 12 will be described, focusing mainly on differences with the exemplary embodiment of FIGS. 5 through 9.

An imprint mold apparatus of an exemplary embodiment of FIGS. 10 through 12 may include a curing unit 50′ having a press element 52 and a first roller 53 attached to an end of the press element 52 and a second roller 54 detaching an imprint mold 10 from a substrate S.

Referring to FIG. 10, a first end of the imprint mold 10 may be placed in contact with photoresist 30. More specifically, the imprint mold 10 is formed of a flexible material. A first end of the imprint mold 10 may be placed in contact with the photoresist 30 first, and then, the rest of the imprint mold 10 may be gradually attached onto the photoresist 30 while gradually increasing the contact area of the imprint mold 10 and the photoresist 30. As a result, a pattern may be formed on the photoresist 30.

As described above, once the first end of the imprint mold 10 is placed in contact with the photoresist 30, the imprint mold 10 may be aligned with the substrate S.

Thereafter, the photoresist 30 may be cured while gradually attaching the rest of the imprint mold 10 onto the photoresist 30. As a result, the contact area between the imprint mold 10 and the photoresist 30 may gradually increase. The imprint mold 10 may be initially wound into a roll. In this case, the imprint mold 10 may be gradually attached onto the photoresist 30 by being gradually unrolled.

The curing unit 50′ may photo-cure part of the photoresist 30 on which the imprint mold 10 is attached, while pressing the imprint mold 10. The curing unit 50′ may include the press element 52 having the first roller 53 attached to the bottom of the press element 52 and a lamp 51 photo-curing the photoresist 30.

The curing unit 50′ may press the imprint mold 10 on the substrate S while slowly moving from the first end to a second end of the imprint mold 10. The direction in which the curing unit 50′ moves may be the same as the direction in which the imprint mold 10 is being gradually attached onto the photoresist 30. The curing unit 50′ may move at the same speed as the speed at which the imprint mold 10 is being gradually attached onto the photoresist 30.

The press element 52 may include the first roller 53 and may thus press the impress mold 10 while rolling on the surface of the imprint mold 10.

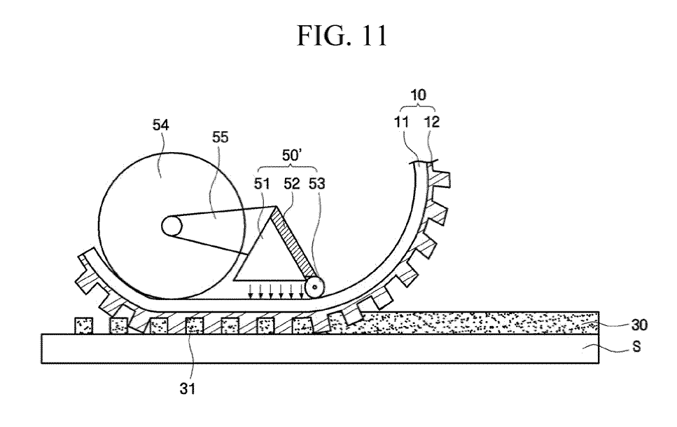

Thereafter, referring to FIG. 11, a pattern 31 may be formed by gradually detaching the imprint mold 10 from the photoresist 30 while gradually attaching the imprint mold 10 onto the photoresist 30.

As described above, the imprint mold 10 may be gradually attached onto the photoresist 30, and the curing unit 50 may move over the imprint mold 10. Part of the imprint mold 10 corresponding to part of the photoresist 30 already cured may be detached from the substrate S.

The curing unit 50′ may also include the second roller 54 connected to the press element 52 by a connecting element 55. The second roller 54 may detach the imprint mold 10 from the substrate S. That is, the first end of the imprint mold 10 may be fixed to the second roller 54. Thus, as the second roller 54 rolls along with the curing unit 50′, the imprint mold 10 may be gradually detached from the substrate S by being wound around the second roller 54.

The second roller 54 may not necessarily have to be coupled to the curing unit 50′. The second roller 54 may move over the imprint mold 10 separately from the curing unit 50′.

The curing unit 50′ and the second roller 54 may sequentially perform pressing the imprint mold 10 on the photoresist 30, photo-curing the photoresist 30, and detaching the imprint mold 10 from the substrate S.

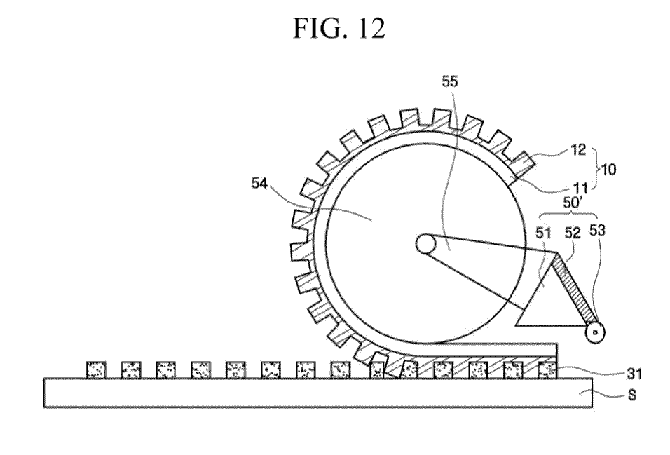

Thereafter, referring to FIG. 12, once the whole imprint mold 10 is processed by the curing unit 50′ and the second roller 54, the imprint mold 10 may be completely detached from the substrate S by being wound around the second roller 54.

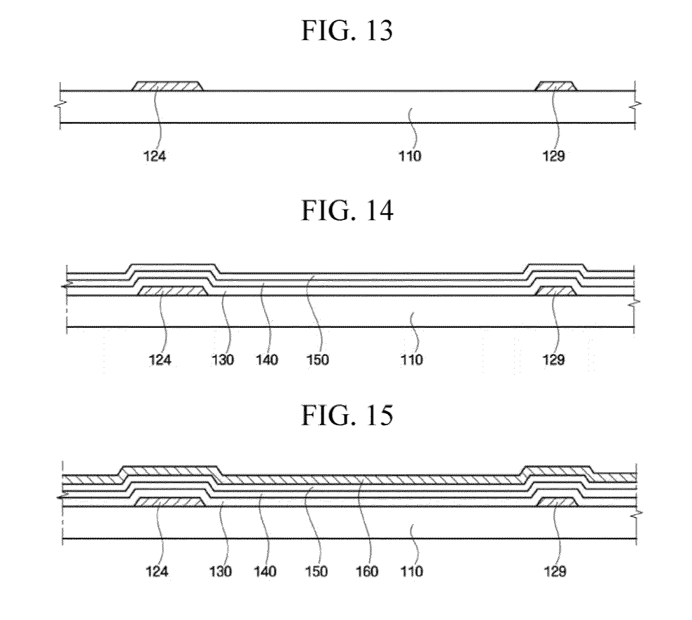

A method of manufacturing a thin-film transistor (TFT) substrate using a method of forming a pattern according to an exemplary embodiment of the present invention will hereinafter be described in detail with reference to FIGS. 13 through 27. FIGS. 13 through 27 are cross-sectional views for illustrating the manufacture of a TFT substrate using a method of forming a pattern according to an exemplary embodiment of the present invention.

Referring to FIG. 13, a conductive layer may be deposited on the entire surface of an insulating substrate 110 using sputtering. The insulating substrate 110 may be formed of glass. The conductive layer may be formed of aluminum (Al), copper (Cu), silver (Ag), molybdenum (Mo), chromium (Cr), titanium (Ti), tantalum (Ta) or an alloy thereof Thereafter, a gate line, a gate electrode 124, a sustain electrode line and a sustain electrode 129 may be formed by performing photolithography on the conductive layer.

Thereafter, referring to FIGS. 13 and 14, a gate insulating layer 130, an amorphous silicon layer 140 and a doped amorphous silicon layer 150 may be formed by consecutively depositing silicon nitride, hydrogenated amorphous silicon and n+ hydrogenated amorphous silicon doped with a high concentration of n-type impurities on the entire surface of the insulating substrate 110 using chemical vapor deposition (CVD).

Thereafter, referring to FIGS. 14 and 15, a data conductive layer 160 may be formed by depositing a conductive metal such as aluminum, copper, silver, molybdenum, chromium, titanium, tantalum or an alloy thereof on the entire surface of the insulating substrate 110.

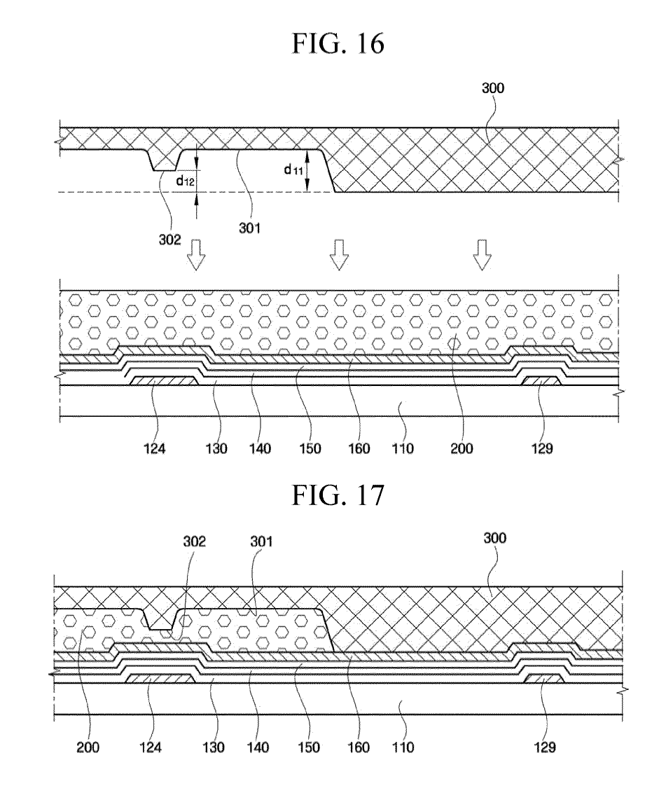

Thereafter, referring to FIGS. 15 and 16, a photoresist layer 200 may be formed on the entire surface of the data conductive layer 160.

An imprint mold 300 including a first recessed pattern 301 for defining a data region and a second recessed pattern 302 for defining a channel region may be prepared.

A depth d11 of the first recessed pattern 301 may be greater than a depth d12 of the second recessed pattern 302. More specifically, the depth d12 may be less than half the depth d11.

Thereafter, the imprint mold 300 may be arranged so that the first and second recessed patterns 301 and 302 can face the photoresist layer 200.

Thereafter, referring to FIGS. 16 and 17, the imprint mold 300 may be pressed on the insulating substrate 110 so that the surface of the imprint mold 300 can reach the data conductive layer 160. As a result, the photoresist layer 200 may be deformed to conform to the shape of the imprint mold 300, as shown in FIG. 16.

Thereafter, the photoresist layer 200 may be cured by performing heat treatment or applying ultraviolet (UV) rays.

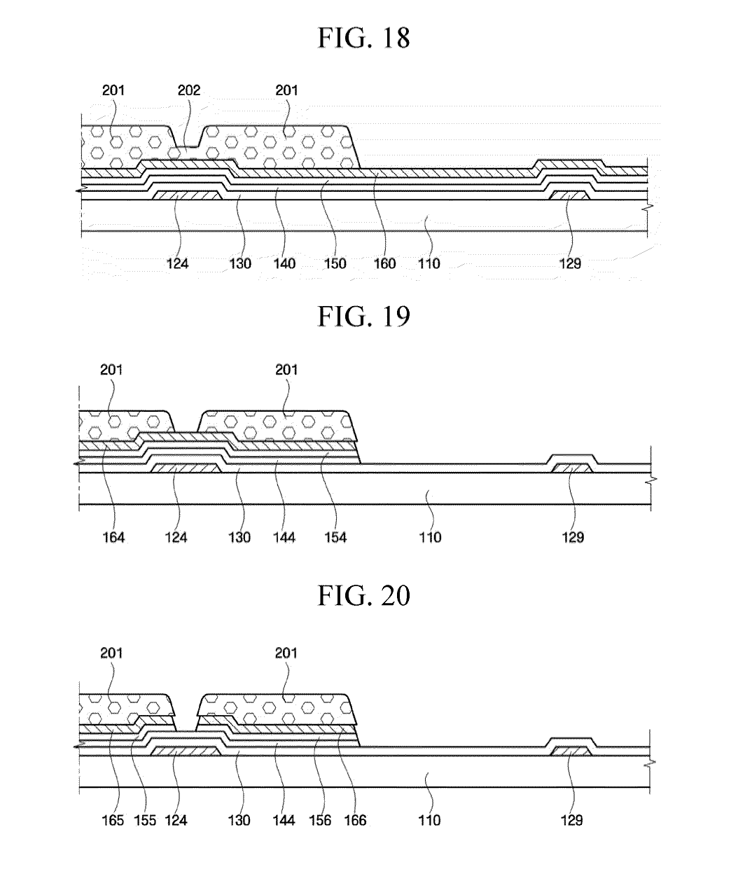

Thereafter, referring to FIGS. 17 and 18, the imprint mold 300 may be removed from the photoresist layer 200. As a result, a first photoresist pattern 201 and a second photoresist pattern 202 may be formed in a data region and a channel region, respectively. The first and second photoresist patterns 201 and 202 may correspond to the first and second recessed patterns 301 and 302, respectively. Since the first photoresist pattern 201 is obtained by transferring the first recessed pattern 301 onto the photoresist layer 200, the thickness of the first photoresist pattern 201 may correspond to the depth of the first recessed pattern 301, i.e., the depth d11. Likewise, since the second photoresist pattern 202 is obtained by transferring the second recessed pattern 302 onto the photoresist layer 200, the thickness of the second photoresist pattern 201 may correspond to the depth of the second recessed pattern 301, i.e., the depth d12. Therefore, the thickness of the first photoresist pattern 201 may be greater than the thickness of the second photoresist pattern 202.

If the photoresist layer 200 still remains in a pixel electrode region, the photoresist layer 200 may be removed from the pixel electrode region by performing an etch-back operation, and thus, the first and second photoresist patterns 201 and 202 may remain only in the data region and the channel region, respectively.

Thereafter, referring to FIGS. 18 and 19, a data conductive layer pattern 164 may be formed by etching the data conductive layer 160 using the first and second photoresist patterns 201 and 202 as etching masks.

Thereafter, a resistive contact layer 154 and a semiconductor layer 144 may be formed by sequentially etching the doped amorphous silicon layer 150 and the amorphous silicon layer 140 using the first and second photoresist patterns 201 and 202 as etching masks. The etching of the doped amorphous silicon layer 150 and the amorphous silicon layer 140 may be performed using a dry etching method. During the etching of the doped amorphous silicon layer 150 and the amorphous silicon layer 140, the first and second photoresist patterns 201 and 202 may be partially etched away, and may thus become thinner.

Thereafter, the second photoresist pattern 202 may be removed from the channel region by performing an etch-back operation on the insulating substrate 110. If the second photoresist pattern 202 has already been removed during the etching of the doped amorphous silicon layer 150 and the amorphous silicon layer 140, the etch-back operation for removing the second photoresist pattern 202 may be skipped. As a result of the removal of the second photoresist pattern 202, the data conductive layer pattern 164 may be exposed.

Thereafter, referring to FIG. 20, the resistive contact layer 154 may be exposed by etching the data conductive layer pattern 164 using the first photoresist pattern 201 as an etching mask. As a result, a source electrode 165 and a drain electrode 166 may be formed in the channel region. The source electrode 165 and the drain electrode 166 may be separate from each other.

Thereafter, the semiconductor layer 144 may be exposed by etching an exposed portion of the resistive contact layer 154. As a result, a resistive contact layer 155 may be formed between the semiconductor layer 144 and the source electrode 165, and a resistive contact layer 156 may be formed between the semiconductor layer 144 and the drain electrode 166.

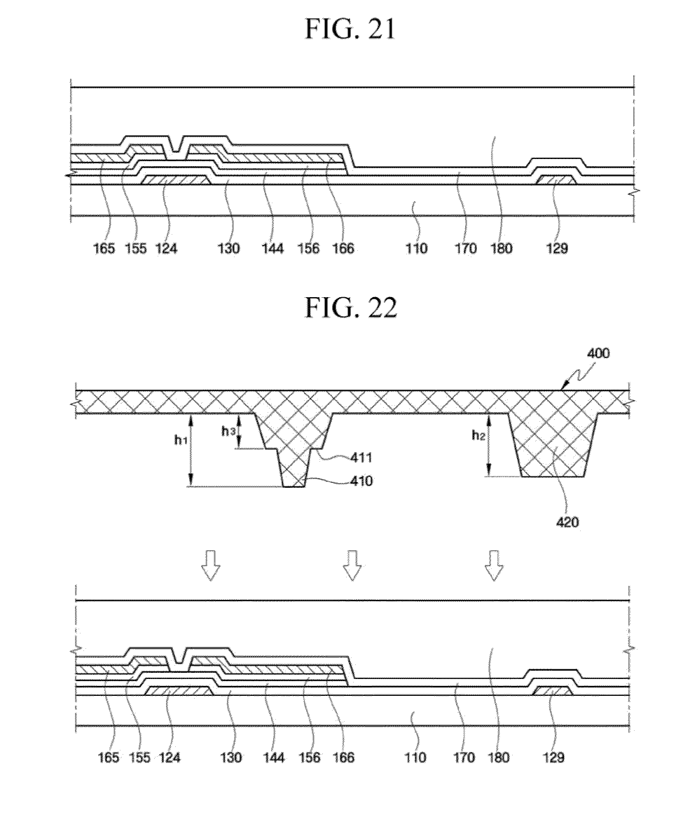

Thereafter, referring to FIGS. 20 and 21, the first photoresist pattern 201 may be removed. Thereafter, a passivation layer 170 may be formed by depositing silicon nitride on the entire surface of the insulating substrate 110. Thereafter, an organic layer 180 may be formed by applying an organic material onto the passivation layer 170.

Thereafter, referring to FIG. 22, an imprint mold 400 including a first protrusion 410 for defining a contact hole region and a second protrusion 420 for defining a sustain electrode region may be prepared. A height h1 of the first protrusion 410 and a height h2 of the second protrusion 420 may be determined such that the distance between the first protrusion 410 and the passivation layer 170 may be less than the distance between the second protrusion 420 and the passivation layer 170 when the imprint mold 400 is pressed on the passivation layer 170. For example, the height h1 may be greater than the height h2.

The first protrusion 410 may have a level-difference pattern 411. A height h3 of the level-difference pattern 411 may be determined such that the distance between the level-difference pattern 411 and the passivation layer 170 may be greater than the distance between the second protrusion 420 and the passivation layer 170 when the imprint mold 400 is pressed on the passivation layer 170. For example, the height h3 may be less than the height h2.

Thereafter, the imprint mold 400 may be arranged so that the first and second protrusions 410 and 420 can face the organic layer 180.

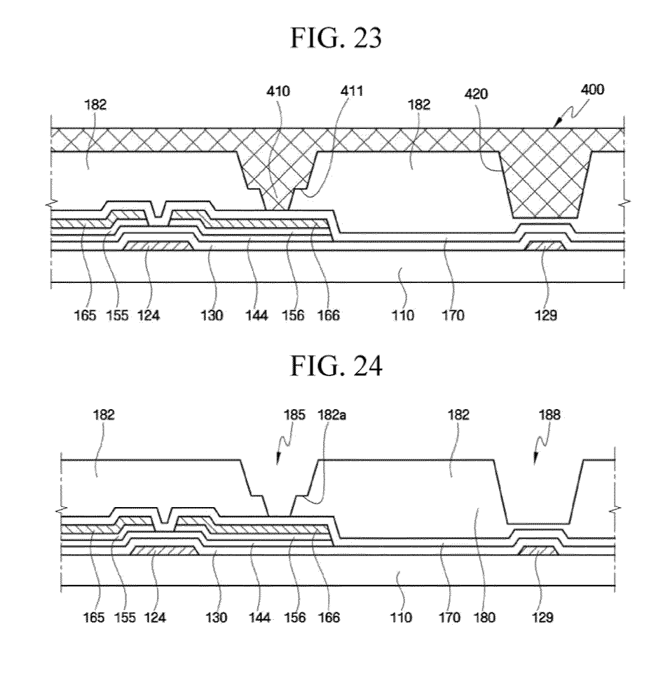

Thereafter, referring to FIG. 23, the imprint mold 400 may be pressed onto the insulating substrate 110 so that the second protrusion 420 can become close to part of the passivation layer 170 on the sustain electrode 129. In this case, the first protrusion 410 may contact part of the passivation layer 170 on the drain electrode 166. The degree to which the first protrusion 410 may penetrate the organic layer 180 depends on the degree to which the imprint mold 400 is pressed onto the insulating substrate 110. In this manner, the organic layer 170 may be deformed to conform to the shape of the imprint mold 400.

Thereafter, the organic layer 170 may be cured by applying UV rays or performing heat treatment.

Thereafter, referring to FIG. 24, the imprint mold 400 may be removed from the organic layer 180. As a result, an organic layer pattern 182 corresponding to the pattern on the imprint mold 400 may be formed. That is, a contact recess 185 corresponding to the first protrusion 410 of the imprint mold 400 may be formed. The contact recess 185 may expose part of the passivation layer 170 on the drain electrode 166. In addition, a level-difference portion 182a corresponding to the level-difference pattern 411 of the first protrusion 410 may be formed in the middle of the organic layer pattern 182. The level-difference portion 182a may be formed below the contact recess 185.

A sustain electrode recess 188 corresponding to the second protrusion 420 of the imprint mold 400 may be formed above the sustain electrode. The distance between the contact recess 185 and the passivation layer 170 may be less than the distance between the sustain electrode recess 188 and the passivation layer 170.

Thereafter, part of the passivation layer 170 below the contact recess 185 may be exposed by performing an etch-back operation on the organic layer pattern 182. The etch-back operation may be performed to not expose part of the passivation layer 170 below the sustain electrode recess 188.

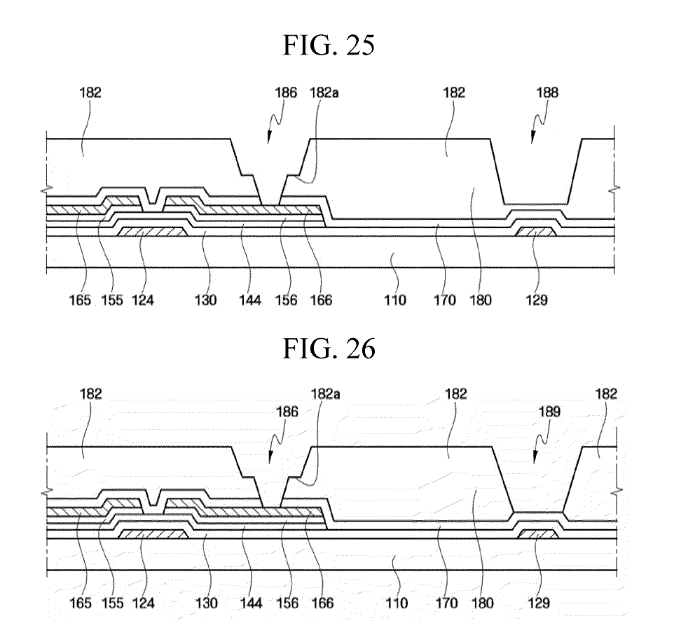

Thereafter, referring to FIG. 25, a contact hole 186 may be formed through the organic layer pattern 182 and the passivation layer 170 by etching part of the passivation layer 170 exposed by the contact recess 185.

Thereafter, referring to FIGS. 25 and 26, part of the passivation layer 170 below the sustain electrode recess 188 may be exposed by performing an etch-back operation on the insulating substrate 110. As a result, a recess 189 may be formed. The recess 189 may expose part of the passivation layer 170 on the sustain electrode 129. During the etch-back operation for forming the recess 189, the height of the organic layer pattern 182 may generally decrease. However, the etch-back operation for forming the recess 189 may be performed such that the level-difference portion 182 can remain even after the etch-back operation for forming the recess 189.

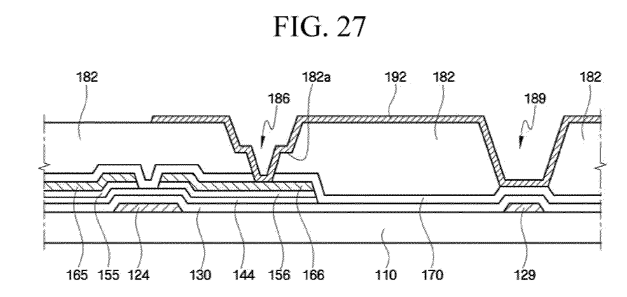

Thereafter, referring to FIG. 27, a pixel electrode 92 may be formed by depositing a transparent conductive oxide material such as indium tin oxide (ITO) or indium zinc oxide (IZO) on the entire insulating substrate 110 and patterning the transparent conductive oxide material.

While embodiments of the present invention has been particularly shown and described with reference to exemplary embodiments thereof, it will be understood by those of ordinary skill in the art that various changes in form and detail may be made therein without departing from the spirit and scope of the present invention as defined by the following claims. Exemplary embodiments should be considered in a descriptive sense only and not for purposes of limitation.

What is claimed is:

1. An imprint mold comprising:
a flexible base plate with a coefficient of thermal expansion (CTE) of about 17 ppm/° C. or less; and
a mold pattern formed on the base pattern.

2. The imprint mold of claim 1, wherein the base plate includes fiber-reinforced plastic.

3. The imprint mold of claim 2, wherein the base plate includes fiberglass.

4. The imprint mold of claim 1, wherein the mold pattern is formed by imprinting a master mold.

5. The imprint mold of claim 1, wherein the base plate is formed of a transparent material.

6. An imprint apparatus comprising:
an imprint mold including a flexible base plate with a coefficient of thermal expansion (CTE) of about 17 ppm/° C. or less, and a mold pattern formed on the base pattern.

7. The imprint apparatus of claim 6, wherein the base plate includes fiber-reinforced plastic.

8. The imprint apparatus of claim 7, wherein the base plate includes fiberglass.

9. The imprint apparatus of claim 6, wherein the mold pattern is formed by imprinting a master mold.

10. The imprint apparatus of claim 6, further comprising a curing unit adapted to pressing and curing the imprint mold when disposed on a substrate, while moving from one end to another end of the imprint mold.

11. The imprint apparatus of claim 10, wherein the curing unit includes a press element disposed at the front of the curing unit and a lamp disposed at the rear of the press element.

12. The imprint apparatus of claim 11, wherein the press element includes a first roller disposed between the press element and the imprint mold.

13. The imprint apparatus of claim 10, further comprising a separating element adapted to being inserted into the substrate and the imprint mold to detach the imprint mold from the substrate.

14. The imprint apparatus of claim 13, wherein the separating element includes a second roller attached to the rear of the curing unit adapted to detaching the imprint mold from the substrate by winding the imprint mold around the second roller.

15. The imprint apparatus of claim 11, wherein the base plate is formed of a transparent material.

16. A method of forming a pattern, the method comprising:
forming an imprint mold including a flexible base plate with a coefficient of thermal expansion (CTE) of about 17 ppm/° C. or less, and a mold pattern which is formed on the base pattern;
applying a curable material on a substrate; and
pressing the imprint mold on the curable material.

17. The method of claim 16, wherein forming the imprint mold comprises impregnating fiberglass with resin.

18. The method of claim 16, wherein the base plate is formed of a transparent material.

19. The method of claim 16, wherein pressing the imprint mold comprises pressing the imprint mold while applying light.

20. The method of claim 16, wherein pressing the imprint mold comprises pressing the imprint mold along a direction from a first end to a second end of the imprint mold and detaching the imprint mold from the substrate along the direction from the first end to the second end of the imprint mold.
